(19) United States
(12) Patent Application Publication
(10) Pub. No.: US 2026/0201127 A1
(43) Pub. Date: Jul. 16, 2026

(54) BIO-BASED POLYMERS

(71) Applicant: Australian National University, Canberra (AU)

(72) Inventors: Luke Andrew CONNAL, Hackett, Australian Capital Territory (AU); Ashwani KUMAR, Higgins, Australian Capital Territory (AU); Brett Leslie POLLARD, Hughes, Australian Capital Territory (AU)

(21) Appl. No.: 19/131,157

(22) PCT Filed: Nov. 27, 2023
(86) PCT No.: PCT/AU2023/051214

§ 371 Date: May 19, 2025

(30) Foreign Application Priority Data
Nov. 28, 2022 (AU) 2022903603

(51) Int. Cl. C08J 3/24; C08J 5/00; C08K 11/00

(52) U.S. Cl. CPC C08J 3/243; C08J 5/005; C08K 11/005

(57) ABSTRACT

The present application provides a composition for the production of a polymer, the composition comprising (i) an epoxidized oil with an iodine value of at least 100; and (ii) a polymer with multiple epoxide-reactive groups. The composition may further comprise a filler, such as spent coffee grounds. The components are available from renewable or waste 5 feedstocks. Also provided are processes for the production of polymers from the composition, and polymers produced therefrom. Polymer, which may be vitrimer type dynamic thermosets in particular, contain a highly crosslinked polymer network with excellent mechanical properties, while allowing for reversible cross-linking and subsequent thermo-reforming and re-use multiple times. The polymers may be fully plant-derived and 0 compostable, addressing an unmet need for biocompatible and sustainable plastics.

### FIELD

The present application relates to compositions for the production of polymers, processes for the production of polymers from the composition, and products formed therefrom. The polymer compositions may comprise plant-derived components and provide a sustainable alternative to comparable polymer compositions.

### BACKGROUND

Petrochemical-based plastics are now widely recognised as an ecological disaster. The production of plastics from finite petrochemical resources, and the resilient nature of plastics in the environment, both pose urgent sustainability issues that require alternatives.

Vegetable oils are an abundant renewable resource that are emerging as a suitable alternative to petrochemical feedstocks for plastic production. Vegetable oil is mainly a mixture of triglycerides with varying composition of long-chain saturated and unsaturated fatty acids depending on the plant, the crop, and the growing conditions. Many of the physical and chemical properties of vegetable oils stem from the relative ratio of saturated and unsaturated fatty acids present in the composition, as well as the degree of unsaturation (i.e. the mean number of double bonds) in the unsaturated fatty acid component. A higher degree of unsaturation in a vegetable oil usually results in the oil being less stable and more susceptible to oxidation. This makes vegetable oils with a higher degree of unsaturation, known widely as “drying” oils, particularly suited to application in coatings and lacquers.

Thermosetting resins have excellent mechanical properties, thermal stability and chemical resistance, but are difficult to recycle due to possessing a permanently crosslinked network structure after curing. Thermoplastic resins can be recycled after heating, but have poor mechanical properties and solvent resistance, and are structurally unstable at high temperatures. Vitrimers are an alternative form of polymer material which combines the good mechanical properties and thermal stability of thermosetting resins, with the reprocessing ability of a thermoplastic resin. Vitrimers are formed by crosslinking reactions to form a covalent network of chemical bonds capable of reversible exchange. As such, the dynamic covalent exchange network of vitrimers allows healing and rework of the polymer material to be achieved while maintaining the structural integrity of the network. These attractive properties make vitrimers particularly useful in applications spanning adhesives, coatings, electronic materials, soft robots and self-healing materials.

Currently, the raw materials for preparing vitrimer type thermosets are conventionally petrochemical-based products. The use of natural renewable, nontoxic and biocompatible biomass raw materials for preparing vitrimer type dynamic thermoset is substantially unexplored but is of great significance.

It is an object of the present application to provide new polymer materials that can be made from renewable resources, and compositions and methods for the production of such polymers. It is an object of preferred embodiments to provide new vitrimer type dynamic thermosetting materials with improved environmental credentials.

### SUMMARY

In one aspect of the present application there is provided a composition for the production of a polymer, the composition comprising:
(i) an epoxidized oil with an iodine value of at least 100; and
(ii) a crosslink agent with multiple epoxide-reactive groups.

Bio-based or plant-derived oils having an iodine value of at least 100 may be suitable feedstocks for component (i). These oils, which may have a plant-based origin, can be readily epoxidized (across the double bonds) and utilised in the production of polymers with favourable properties.

Bio-based or plant derived crosslink agents containing epoxide-reactive groups may be suitable for use as component (ii). Suitable crosslink agents may be small molecules or polymers containing two or more epoxide-reactive groups, or mixtures and/or combinations of small molecules and polymers.

In one embodiment, component (ii) comprises a small molecule with two carboxylic acid groups, termed a diacid. Suitably, component (ii) has a Mw not exceeding 160 g/mol. More suitably, component (ii) has a Mw not exceeding 135 g/mol. Even more suitably, component (ii) comprises malic acid or tartaric acid.

Malic acid provides two carboxylic acid groups which are reactive with epoxide groups of an epoxidized oil to crosslink between oil molecules and form a polymer network. Malic acid can further be suitably bio-based, or plant derived. In another aspect of the present application there is provided a composition for the production of a polymer, the composition comprising:
(i) an epoxidized oil with an iodine value of at least 100; and
(ii) a polymer with multiple epoxide-reactive groups.

Bio-based or plant derived polymers containing epoxide-reactive groups may be suitable for use as component (ii). In one embodiment, component (ii) is a polymeric poly-carboxylic acid. A number of plant-derived polymeric poly-carboxylic acids are available and suitable for use as component (ii) as described in further detail below.

The composition may further comprise (iii) a filler, which may in some embodiments comprise a plant-derived particulate waste product. An example of this component, among others, is spent coffee grounds.

The inventors have discovered the unexpected combination of an epoxidized, high iodine value plant oil with a bio-based or plant-derived diacid and/or poly-carboxylic acid forms a highly crosslinked polymer network with excellent mechanical properties. The further addition of a plant-derived filler to the composition results in a polymer with improved strength and even greater resilience to stress. Importantly, in some embodiments, polymer articles formed from the composition may be fully plant-derived and compostable, addressing an unmet need for sustainable plastics. It is further found that such polymer compositions may have the properties of vitrimers, allowing for reversible cross-linking and subsequent thermo-reforming and re-use multiple times, while maintaining the structural integrity of the polymeric network in the manner of a vitrimer.

In another aspect of the present application, there is provided a process of using the above-mentioned compositions to produce a polymer.

In one embodiment, the present invention provides a process for the production of a polymer comprising subjecting a composition comprising:
(i) an epoxidized oil with an iodine value of at least 100 and
(ii) a crosslink agent with multiple epoxide-reactive groups to cross-linking conditions to produce the polymer.

The cross-linking conditions may comprise heating at a temperature of at least 120° C., suitably between 12° and 150° C.

An advantage of the composition and process is the fact that a catalyst is not required for the cross-linking process. The cross-linking can be conducted under substantially solvent-free conditions. Similarly, the composition used in the process may also be substantially solvent free (i.e. less than 4% solvent or no solvent). Whilst these conditions are preferred, the polymer may be produced via different reaction conditions that may include a catalyst and/or solvent, if so desired.

In another aspect there is provided a polymer produced from a composition comprising:
(i) an epoxidized oil with an iodine value of at least 100, and
(ii) a crosslink agent with multiple epoxide-reactive groups.

In some embodiments, the polymer is a vitrimer or a vitrimer type dynamic thermoset. Vitrimers comprise dynamic covalent cross-linking bonds and are thermo-reforming and self-healing.

In some embodiments, the crosslinked polymer suitably possesses a Young's modulus of at least 1,500 kPa, or at least 5,000 kPa. More suitably, the polymer possesses a Young's modulus of at least 10,000 kPa.

The polymer may thermo-reform and/or self-heal when subjected to a temperature of at least 120° C., suitably ranging from 120-170° C., more suitably 150-160° C.

In preferred embodiments, the polymer is compostable in accordance with the test set out in Australian Standard AS 4736-2006.

In another aspect, the present application provides a polymer produced from (i) a plant-derived oil and (ii) a plant-derived diacid crosslink agent, suitably an alpha hydroxyl diacid crosslink agent.

The polymer optionally comprises a crosslink agent comprising a polymer with multiple epoxide-reactive groups. The polymer may further comprise a bio-based filler. In preferred embodiments, substantially all constituents of the polymer are derived from plant materials or bio-based materials. In preferred embodiments, the polymer is a vitrimer type dynamic thermoset, or a bio-based vitrimer type dynamic thermoset. The present application also provides processes for the production of this polymer, and compositions suitable for the production of the polymer. Such a composition comprises (i) a plant derived oil and (ii) a plant-derived alpha hydroxyl diacid and/or a plant-derived polymeric poly-carboxylic acid. It is believed that the production of vitrimer type dynamic thermoset from such plant-derived cross-linkable components have been made for the first time, and this provides a notable advance in the art.

### BRIEF DESCRIPTION OF THE DRAWINGS

The invention will now be described in further detail with reference to preferred embodiments and test work, and the following figures, in which:

FIG. 1: provides illustrative chemical structures of a polymer containing multiple carboxylic acid groups (alginic acid) and an epoxidized oil that are components of a polymer composition and polymer in accordance with some embodiments of the invention.

FIG. 2: provides Fourier Transform Infrared (FTIR) spectra for test samples produced in accordance with embodiments of the invention consisting of different weight % concentrations of filler (spent coffee grounds).

FIG. 3: provides (a) a differential scanning calorimetry profile and (b) a thermogravimetric analysis profile for test samples produced in accordance with embodiments of the invention consisting of different weight % concentrations of filler (spent coffee grounds).

FIG. 4: provides scanning electron micrographs of test samples produced in accordance with embodiments of the invention consisting of different concentrations of filler (spent coffee grounds)—including (a) 0% w/w of spent coffee grounds, and (b) 30% w/w of spent coffee grounds.

FIG. 5: provides mechanical testing data (stress relaxation) of test samples produced in accordance with embodiments of the invention. This includes (a) normalised stress relaxation at 150° C., (b) stress relaxation of polymer containing 30 wt % coffee grounds at different temperatures; and (c) activation energy of polymer containing 30 wt % coffee grounds.

FIG. 6: provides photographs of test samples produced in accordance with embodiments of the invention, in the form of a compostable plant pot. Figure (a) is a pot directly obtained from mould, before planting and showing cleanly defined lines, and figure (b) is an image taken after planting a jelly bean plant. The dimensions are 55 mm (height)×50 mm (circumference).

FIG. 7: provides mechanical testing data (uniaxial tensile testing) of test samples produced in accordance with embodiments of the invention. This includes (a) stress-strain of samples formed using different carboxylic acid crosslinkers, (b) stress-strain of pristine filament and re-extruded 7^{th} filament produced in accordance with embodiments of the invention containing 15 wt % filler.

### DETAILED DESCRIPTION

### Bio-Based Polymer Composition

In one aspect of the present application there is provided a composition for the production of a polymer, the composition comprising:
(i) an epoxidized oil with an iodine value of at least 100; and
(ii) a crosslink agent with multiple epoxide-reactive groups.

The inventors have discovered that by combining an epoxidized derivative of a high iodine value oil with a crosslink agent containing multiple epoxide-reactive groups, polymers can be formed via crosslinking that possess advantageous mechanical properties.

The “composition for the production of a polymer” or “polymer-forming composition” may both also be referred to as a “polymer composition”, for brevity.

The source of each one of the components of the polymer composition is preferably bio-based or plant based. “Bio-based” means that the component (e.g. compound or substance) is substantially renewable and is essentially biological in origin. The term “bio-based” excludes materials that are petrochemical resources or are substantially derived from petrochemical resources or crude oil. Examples of bio-based materials are outlined below in relation to each component of the polymer composition. “Plant-derived” means that the component (e.g. compound or substance) essentially originates in a plant. A plant-derived component is a component that can be harvested from any part of plant, such as roots, stems, leaves, flowers, fruits, or seeds/nuts. The expression “plant-derived component” extends to any component that can be derived through a simple chemical transformation of a compound that is be harvested from a plant. Examples of simple chemical transformations include hydrolysis of triglyceride oils that are produced by plants, and a chemical reaction of a single functional group such as epoxidation of a double bond present in the plant-derived component. Plants and their waste products following processing are renewable resources, as opposed from petroleum-derived products. Both bio-based and plant-derived can refer to compounds that are naturally occurring or are produced through genetic modification and/or synthetic biology.

Synthetic biology represents a range of chemical and biological manipulations that can be undertaken to cause a particular species of plant, animal or fungi to generate a chemical compound that it does not naturally produce in the same concentration and under the same conditions during normal biology. Synthetic biology can represent a viable alternative to producing any/all of the components used in the production of the polymer compositions and polymers of the present application.

### Epoxidized Oil

The first component of the polymer composition is an epoxidized oil. The term “epoxidized oil” refers to an oil that has been epoxidized.

“Oil” is a term in the art that refers to a mixture of fatty acid triglycerides and/or free fatty acids. A fatty acid triglyceride is a trimer of fatty acid esters that are covalently attached through their carboxylate end to a single glycol group. The triglyceride component of the oil comprises fatty acid esters with aliphatic chains of between 8 and 35 carbon atoms in length. The term “aliphatic or “aliphatic chain” means a saturated or unsaturated linear (i.e., straight chain), or branched hydrocarbon group. While some fatty acids in the oil may be saturated, it will be understood that there must be some fatty acid chains that are unsaturated in the oil to allow for epoxidation of the fatty acid. The term “aliphatic” refers to alkyl (e.g. —C₁₂H₂₅) (or alkylene if within a chain such as —C₁₂H₂₄—), alkenyl (or alkenylene if within a chain), and alkynyl (or alkynylene if within a chain) groups. The term “alkenyl group” means an unsaturated, linear or branched hydrocarbon group with one or more olefinically unsaturated groups (i.e., carbon-carbon double bonds). The triglyceride component may comprise a blend of different fatty acid esters with varying numbers of alkenyl groups. The degree of unsaturation of each fatty acid chain is defined by the number of alkenyl groups in the fatty acid ester chain. For example, a polyunsaturated triglyceride contains fatty acid chains with two or more alkenyl groups.

The degree of unsaturation of an oil may be assessed by reference to its iodine value. An iodine value represents the degree of unsaturation within the triglyceride components of the oil. Iodine reacts with the double bonds of an unsaturated oil and is therefore consumed during reaction with the oil. Higher iodine values therefore represent oils with higher degrees of unsaturation. The number represented by an iodine value is the grams of iodine (I₂) that is consumed through reaction with 100 grams of an oil. The units for an iodine value are grams of iodine consumed per 100 grams of oil.

While an iodine value may be measured by any known technique, to allow for accurate comparison to the limits set out herein, the iodine value should be measured in accordance with the “standard test method for the determination of the iodine value of fats and oils” under International Standard ASTM D5554-15 (2021).

It will be noted that the references to an iodine value in the present application refer to the iodine value of the oil itself—that is, prior to epoxidation. Epoxidation of the oil changes the iodine value, given the conversion of the double bonds to epoxide groups during that conversion step.

In some embodiments, the oil component has an iodine value of at least 100, at least 130, at least 140, at least 150, at least 160, at least 170, at least 180, at least 190, or at least 200, prior to epoxidation.

In a preferred embodiment, the epoxidized oil component has an iodine value of at least 100, at least 130, at least 140, or at least 150, prior to epoxidation.

In a particularly preferred embodiment, the oil is a bio-based or plant-derived oil with an iodine value of at least 100.

By having an iodine value greater than 130 it is meant that the oil is considered by those skilled in the art to be a “drying oil”. By having an iodine value of 100-130 it is meant that the oil is considered by those skilled in the art to be a “semidrying oil”. Drying oils (or semidrying oils) is a term used in some industries to refer to those oils that increase in thickness and/or hardness on standing in air, and are therefore most suited to use in coatings, lacquers and paints. The types of oils suited to the present application are among those oils that may be described as drying oils or semidrying oils. The desirable properties of drying oils and semidrying oils for some industries are associated with their high degree of unsaturation. In the context of the present application, a high degree of unsaturation results in a high concentration of epoxide groups following derivatisation of the double bonds of the unsaturated oil by epoxidation.

Higher concentrations of epoxide groups in the epoxidized oil provides higher cross-linking density in the network formed by reacting the epoxidized oil with an epoxide-reactive crosslinking agent. Higher cross-linking density is advantageous for providing better mechanical properties in products formed from the composition.

The term “bio-based” in relation to oil encompasses any plant oil, any animal fat, plant and animal waxes, including insect waxes (provided the wax contains fatty acid esters), or other plant/animal/insect-sourced fatty esters. The term “bio-based” excludes materials that are petroleum-derived oils, or are obtained from petrochemical resources, or are substantially derived from petrochemical resources. “Plant-derived” means that the oil essentially originates in any part of a plant. In another embodiment, the oil is a comprised of a genetically modified analogue of a naturally-occurring oil, triglyceride or fatty acid ester.

Suitable sources of the oil in the present application include Chia seed oil, Dammar oil, Linseed oil, Poppyseed oil, Stillingia oil, Safflower oil, Perilla oil, Sunflower oil, Vernonia oil, Tung oil, algal oil, Tall oil, Walnut oil and other polyunsaturated plant-derived oils (both naturally existing and genetically modified), or combinations of two or more thereof. These are all plant-derived oils and have an iodine value above 100, or are available with a range of iodine values, and may have an iodine value above 100 depending on the specific source.

As an illustrative example, the iodine values of some of these oils are typically as follows:

| Oil | Iodine value |
|---|---|
| Chia seed oil | 209-211 |
| Linseed | 175-195 |
| Tall oil | 165-170 |
| Tung | 158-180 |
| Safflower | 135-148 |
| Soyabean | 129-143 |
| Sunflower | 112-138 |
| Algal Oil | 100-120 |

In preferred embodiments, the epoxidized oil is epoxidized chia seed oil, linseed oil, tall oil or tung oil. Such oils conventionally always have an iodine value above 100.

As noted above, the oil component (i) may comprise a combination of two or more different oils. Thus, as one illustrative example, a combination of 50% chia seed oil and 50% sunflower oil may be used. The overall iodine value will be based on the measured iodine value of the blended oil. Typically, the iodine value of an oil comprising 50% of each of two oils will be the average of the iodine values of the two oils. However, a measure of the iodine value of the blended oil using the ASTM standard should be relied on for the specific iodine value of the blend.

Component (i) in the polymer composition is an epoxidized oil. Epoxidized/expoxidation refers to the conversion of double bonds present in the fatty acid chains of the oil to epoxide functional groups. The term “epoxide” may also be described as an ethylene oxide group or an oxirane functional group. The conversion of the double bonds present in the fatty acid chains of the oil may be partial or complete. In preferred embodiments, the epoxidation conversion is at least 80%, at least 85%, at least 90%, at least 92%, at least 93%, at least 94%, or at least 95% complete. In a most preferred embodiment, the epoxidation conversion is at least 95%. The extent of epoxidation conversion can be determined by NMR analysis.

Methods for epoxidizing double bonds (i.e. converting alkenyl groups to oxirane groups) are known in the art. Examples include reacting the oil with a suitable oxidising agent such as hydrogen peroxide, hypochlorous acid, formic acid or combinations thereof. One suitable epoxidizing reaction involves reacting the oil with hydrogen peroxide in the presence of formic acid. Another suitable epoxidizing reaction involves enzyme-catalysed epoxidation using an enzyme, such as a lipase. A small number of epoxidized oils are also available from commercial chemical supply companies, although to date, the epoxidized oils commercially available are based on oils with lower iodine values. In future, and subject to industry demands, commercial supplies of epoxidized oils based on oils with higher iodine values may become available.

In some embodiments, the epoxidized oil constitutes at least 20%, at least 30%, at least 35%, at least 40%, or at least 45% by weight based on the total weight of the polymer composition. The epoxidized oil suitably constitutes at least 20% by weight of the polymer composition, more suitably ranging from 50%-90% by weight of the polymer composition.

If the polymer composition contains low or no filler (i.e. less than 30% filler, less than 20% filler, or 10% or less of filler), then the amount of epoxidized oil in the polymer composition may be higher. For example, the amount of epoxidized oil may constitute at least 50%, at least 55%, at least 60%, at least 65% or at least 70% of epoxidized oil. In some embodiments the amount is about 80%.

In some embodiments, the amount of epoxidized oil is not more than 90% by weight of the polymer composition. If the composition contains filler, then the amount may be lower again. The amount in some embodiments may be not more than 80%, or not more than 70% or not more than 60% by weight of the polymer composition.

Crosslinker with Multiple Epoxide-Reactive Groups

The second component (component (ii)) of the polymer composition is the crosslink agent with multiple epoxide-reactive groups. This component functions to crosslink the epoxidized oil molecules to form a continuous polymer network.

In preferred embodiments, component (ii) is bio-based or plant-derived. The term “bio-based” means that component (ii) is substantially renewable and is essentially biological in origin. The term “bio-based” excludes materials that are petroleum-derived, or are obtained from petrochemical resources, or are substantially derived from petrochemical resources. “Plant-derived” means that polymer used as component (ii) essentially originates in any part of a plant. In another embodiment, component (ii) may comprise a genetically modified analogue of a naturally occurring polymer with multiple epoxide reactive functional groups.

Epoxide-reactive groups are functional groups that react with epoxides. The type of reaction is the formation of a covalent crosslink by ring-opening of the epoxide via nucleophilic addition. Examples of suitable epoxide-reactive groups are carboxylic acids (and salts or esters thereof), alcohols, amines and anhydrides.

The reaction of the epoxide-reactive group with the epoxide suitably forms a new covalent cross-link between the oil component (via the location of the epoxide group) and the polymer component (via the epoxide reactive functional group).

The crosslink agent, or crosslinker, undergoes covalent bond-forming reactions with two or more epoxidized oil molecules. Thus, the crosslink agent links or bridges multiple oil molecules together through formation of a new covalent network. The new covalent network constitutes a crosslinked polymer network composed of oil molecule residues and crosslink agent molecule residues. The product of the crosslinking reaction is a crosslinked polymer article.

The new covalent crosslink can take the form of a range of different chemical groups, such as alkoxy alcohol (ether alcohol), hydroxy ester (ester alcohol), amino alcohol (amine alcohol), amido alcohol (amide alcohol) or alkyl (aliphatic alcohol). It is advantageous for embodiments of the present application that the new crosslink bond takes the form of a dynamically reversible covalent bond. The crosslink bond being reversible means that the crosslink reaction can be reversed to regenerate the epoxide and epoxide-reactive starting functional groups under certain conditions. The crosslink bond being dynamically reversible means that the bond can be repeatedly formed and reversed between the same pair, or a different pair, of epoxide and epoxide-reactive groups. Some examples of reversibly dynamic covalent bonds include esters, oximes and amides. Dynamically reversible covalent bonds are advantageous for providing thermo-reforming and self-healing in vitrimer and vitrimer type dynamic thermoset materials.

In some embodiments, the crosslink agent is a small molecule with two or more carboxylic acid groups. Where the crosslink agent is a molecule with two carboxylic acid groups, the crosslink agent may be referred to as a diacid. A range of bio-based or plant-derived diacids are available in the art, including malic acid, tartaric acid, malonic acid, succinic acid, glutaric acid, adipic acid, pimelic acid, suberic acid, azelaic acid, amongst others. Some embodiments may comprise citric acid as crosslink agent, which comprises three carboxylic acid groups and may be termed a triacid.

In preferred embodiments, component (ii) is an alpha hydroxyl diacid. Without being bound by theory, the carboxylic acid groups of an alpha hydroxyl diacid have increased nucleophilic reactivity with an epoxide group compared with a diacid without an alpha hydroxyl group. The effect of the increased reactivity is to facilitate the crosslink reaction between the diacid and epoxide group. Most preferably, component (ii) is malic acid or tartaric acid.

It has been unexpectedly discovered that a polymer article produced from a composition comprising malic acid as component (ii) exhibits higher toughness and Young's modulus than an equivalent composition comprising citric acid or alginic acid as component (ii).

It has further been discovered that a polymer article produced from a composition comprising citric acid as component (ii) advantageously exhibits porosity. Without being bound by theory, its is believed that crystals of citric acid contain water of crystallisation (C₆H₈O₇·nH₂O) that is converted into water vapour during crosslinking, which forms internal voids within the polymer network and results in a porous polymer article. Where a polymer article without porosity is desirable, citric acid is less suitable as component (ii).

The crosslinking reaction between a diacid and an epoxidized oil produces an ester crosslink between the two components. Additionally, the crosslinking reaction generates a secondary alcoholic unit on the oil side of the ester crosslink. The ester crosslink is capable of dynamic reversible covalent exchange with the secondary alcohol functional unit. This ester-alcohol exchange can additionally provide for thermo-reforming and self-healing properties to the crosslinked polymer.

In some embodiments, the crosslink agent containing multiple epoxide-reactive functional groups constitutes at least 1%, at least 2%, at least 5%, at least 8%, or at least 10% by weight based on the total weight of the polymer composition. If the polymer composition contains low or no filler (i.e. no more than 30% filler, no more than 20% filler, or 10% or less of filler), then the amount of crosslink agent containing multiple epoxide-reactive functional groups in the polymer composition may be higher. For example, the amount of crosslink agent containing multiple epoxide-reactive functional groups may constitute at least 12%, at least 14%, at least 16%, at least 18% or at least 20% of epoxidized oil. In some embodiments the amount is about 15%.

In some embodiments, the amount of crosslink agent containing multiple epoxide-reactive functional groups is not more than 30% by weight of the polymer composition. If the composition contains filler, then the amount may be lower again. The amount in some embodiments may be not more than 25%, or not more than 23% or not more than 21% by weight of the polymer composition.

In some embodiments, component (ii) has an average molecular weight not exceeding 160 g/mol. More suitably, component (ii) has a Mw not exceeding 135 g/mol.

Polymer with Multiple Epoxide-Reactive Groups

In other embodiments the second component (component (ii)) of the polymer composition is a polymer with multiple epoxide-reactive groups. This component functions as a crosslinking agent.

In the context of the present application, the term “polymer” (and similar terms, such as “polymeric component”) refers to a compound comprising two or more covalently bound repeating monomeric units. In the case of component (ii), each monomeric unit suitably comprises an epoxide-reactive group, examples of which are described in further detail below. The repeating units may be regular or irregular. In the case of bio-based polymers with multiple epoxide-reactive groups, the structure may be irregular and the number of repeat units may not be quantified, but they are typically greater than 5 repeat units. Having a higher number of repeat units for the polymer provides for suitable mechanical properties for the polymeric product.

In some embodiments, the repeated monomeric units may be derived from aldohexose sugar units. Examples include mannose and gulose units. These may be in the carboxylic acid forms-such as the uronic acid forms—including mannuronic acid and guluronic acid, and combinations thereof.

In some embodiments, the polymer with multiple epoxide-reactive groups has an average molecular weight of at least 2, at least 5, at least 10, at least 50, at least 100 or at least 150 kDa. The average molecular weight may in some embodiments be less than 500 kDa, less than 400 kDa or less than 350 kDa.

In some embodiments, at least 50 mol % of the repeat monomeric units of the polymer of component (ii) comprise one (or more) epoxide-reactive group(s). In preferred embodiments, at least 80% or at least 90% or all repeat monomeric units of the polymer of component (ii) comprise one (or more) epoxide-reactive group(s).

In the case of a polymeric poly-carboxylic acid, the degree of carboxylation in some embodiments is about 10% to 35%. For example, the degree of carboxylation may be around 22%. The degree of carboxylation is frequently reported by reagent suppliers, or may alternatively be determined by suitable analytical techniques such as acid-base titration.

The polymer of component (ii) can have non-uniform sequencing. Non-uniform sequencing means that the polymer comprises a portion of monomeric units that differ in respect of chemical functionality from the predominant monomer units of the polymer. Imprecise sequencing means that some monomeric units comprise a different number of epoxide-reactive groups, or no epoxide reactive-groups. Non-uniform sequencing can occur naturally in polymers of bio-based or plant-derived origin. Non-uniform sequencing may also be of synthetic origin, and formed by chemical transformation of the polymer.

In some embodiments, the epoxide-reactive group is a carboxylic acid group or a salt or ester thereof. Therefore, the second component may in some embodiments be a polymeric poly-carboxylic acid. These are sometimes shortened to “poly-acids” or “polyacids”.

A range of natural polyacids is available in the art. That is, a number of bio-based or plant-derived polyacids are available in the art. The meaning of “bio-based” and “plant-derived” is as described above. Examples of suitable polyacids in this class include carboxylated polysaccharides, alginic acid, polylactic acid, polyacrylic acid, polymethacrylic acid, pectins, glycosaminoglycans, hyaluronic acid, tannic acid, or salts or esters of the above, or combinations of two or more thereof.

A combination of two or more different polymers with multiple epoxide-reactive groups (e.g. two different polyacids) may be used as component (ii). The blended ratio may be anywhere from 1:99 to 99:1. A combination of a small molecule crosslink agent with multiple epoxide-reactive groups and a polymer with multiple epoxide-reactive groups may be used as component (ii). The blended ratio may be anywhere from 1:99 to 99:1.

While not constituting a (polymeric) polyacid, citric acid, itaconic acid, citraconic acid or other natural acids with two or more carboxylic acid groups may be used in combination with the polymeric polyacids in the formulations. These may function as additional crosslinking agents, as described further below.

Surprisingly, and advantageously, by reacting a polyacid with an epoxidized oil, a crosslinked polymer is obtained with very good mechanical properties. Reacting a polyacid with an epoxidized oil forms a crosslinked polymer with desirable mechanical properties. A crosslinked polymer with further improved mechanical properties may be obtained by reacting a small molecule diacid such as malic acid and a polyacid with an epoxidized oil. The inventors have discovered that the multitude of both epoxide groups on the epoxidized oil, and carboxylic acid groups on the diacid and polymer polyacid, are beneficial by providing multiple points of crosslinking and different lengths of crosslinks, i.e. higher crosslinking density and crosslink length diversity. High crosslinking density increases the strength of the polymer formed by crosslinking. Furthermore, crosslink length diversity imparts mechanical properties associated with each of the crosslink lengths, where shorter lengths provide stiffness and rigidity, and longer lengths provide flexibility and elasticity.

The crosslinking reaction between a polyacid and an epoxidized oil produces an ester crosslink between the two components. Additionally, the crosslinking reaction generates a secondary alcoholic unit on the oil side of the ester crosslink. The ester crosslink is capable of dynamic reversible covalent exchange with the secondary alcohol functional unit. This ester-alcohol exchange can additionally provide for thermo-reforming and self-healing properties to the crosslinked polymer.

In some embodiments, the polymer containing multiple epoxide-reactive functional groups constitutes at least 1%, at least 2%, at least 5%, at least 8%, or at least 10% by weight based on the total weight of the polymer composition. If the polymer composition contains low or no filler (i.e. no more than 30% filler, no more than 20% filler, or 10% or less of filler), then the amount of polymer containing multiple epoxide-reactive functional groups in the polymer composition may be higher. For example, the amount of polymer containing multiple epoxide-reactive functional groups may constitute at least 12%, at least 14%, at least 16%, at least 18% or at least 20% of epoxidized oil. In some embodiments the amount is about 15%.

In some embodiments, the amount of polymer containing multiple epoxide-reactive functional groups is not more than 30% by weight of the polymer composition. If the composition contains filler, then the amount may be lower again. The amount in some embodiments may be not more than 25%, or not more than 23% or not more than 21% by weight of the polymer composition.

### Additional Cross-Linking Agents

The polymer with multiple epoxide-reactive groups described above provides for cross-linking with the epoxidized oil component. The polymer composition may additionally comprise one or more additional cross-linking agent(s). The additional cross-linking agents may be covalent cross-linking agents or ionic cross-linking agents. In some embodiments, the polymer composition contains an ionic crosslinking agent. A range of ionic cross-linking agents are known and used in the art. Examples of suitable ionic crosslinking agents include:
Calcium chloride or other calcium salts (e.g. sulphate, carbonate, etc.)
Other halides of divalent metals (e.g. Magnesium chloride, etc.)
Divalent or polyvalent metal compounds, such as metal oxides (e.g. zinc oxide, magnesium oxide) and metal hydroxides (aluminium hydroxide).

In other embodiments, the polymer composition comprises a covalent crosslinking agent (the covalent cross-linking agent being other than component (ii)). The covalent cross-linking agents may comprise two or more epoxide reactive groups. Examples of suitable covalent crosslinking agents include:
Difunctional compounds comprised of two identical epoxide-reactive functional groups, including diacids, such as Oxalic acid, Malonic acid, Succinic acid, Glutaric acid, Adipic acid, Pimelic acid, Suberic acid, Azelaic acid, and mixtures thereof.
Trifunctional compounds comprised of three identical epoxide-reactive functional groups, including triacids, such as Citric acid and salts and esters thereof.
Lewis acid type curing compounds comprised of metal salts, including Tin octoate, Zinc acetylacetonate, Zinc acetate, and mixtures thereof.

The amount of additional cross-linking agent may be from 0-30% by weight, typically 0-20% by weight or 0-10% by weight. When present, the amount may be 0.1%-10% by weight, or 0.1-5% by weight.

In alternative embodiments, the polymer composition and polymer produced therefrom is free of covalent cross-linking agents other than component (ii). In some such embodiments, the polymer composition and polymer produced therefrom is free of ionic cross-linking agents and free of covalent cross-linking agents other than component (ii).

### Bio-Based Filler

The polymer composition may additionally comprise a filler. The filler may be a particulate filler. The filler is preferably bio-based or plant-derived origin. Fillers are well known in the art as an additive to polymer compositions to provide bulk volume to the polymer composition. They may alternatively be referred to as “bulking agents”.

The filler may be organic or inorganic. The filler is preferably an organic filler. The filler may be a particulate filler. The particulate filler is more preferably a bio-based or plant-derived particulate filler. The term “bio-based” means that the filler is substantially renewable and is essentially biological in origin. The term “bio-based” excludes materials that are petroleum-derived, or are obtained from petrochemical resources, or are substantially derived from petrochemical resources. “Plant-derived” means that the filler essentially originates in any part of a plant. In a preferred embodiment, the filler is comprised of a plant-derived, recovered waste material.

In some embodiments, the filler is a fibre-based filler. Fibres are particles with an aspect ratio of at least 3:1. Aspect ratio is the ratio of the length to the width (length:width) of the particle, where the cross-section of the fibre is approximately circular. For example, fibres suitable for the present invention can have aspect ratios of 4:1, 5:1, 6:1 or higher. The cross-section of a fibre can also take forms other than spherical, defined in the art as the “shape-factor” of the fibre, including for example, oval, multi-lobal, triangular, serrated, kidney bean, dog-bone, hollow or square, or any other shape factor. Fibres are well known as polymer fillers in the art for increasing mechanical properties of a polymer article, such as flexural modulus and/or tensile strength. Fibres suitable for use as filler in the polymer composition include, plant-derived cellulose and lignocellulosic fibres such as lignin, starch, cotton, bagasse, lacebark, coconut husk, hemp, flax, jute or wood fibres, wool, silk or hair, glass fibres, carbon fibre, and regenerated cellulosic fibres, such as rayon and diacetate/triacetate fibre. In a preferred embodiment the fibre filler is plant-derived.

In some embodiments, the filler is a particulate filler. The particles may have an aspect ratio that is less than 3:1. The particles may be described as approximately spherical. The particles may have aspect ratio of between than 3:1 and 1:0.33. For example, particles suitable for the polymer composition can have an aspect ratio of 2:1, 1:1 or 1:0.5. In some embodiments, the filler particles have a median particle size (D₅₀) of between 100 nm-2 cm, preferably between 1 μm-1.5 cm, still more preferably of from 100 μm-1 cm as measured using, for example, electron microscopy or by using a conventional laser diffraction particle sizing method as embodied by a MALVERN Mastersizer S or MALVERN Mastersizer 2000 apparatus. Particulate fillers are well known as polymer fillers in the art for increasing mechanical properties of a polymer article, such as harness and tear resistance. Particles suitable for use as filler in the polymer composition can include any bio-based or plant-derived particles, such as cellulose, hemicellulose and lignin particles from coffee grounds, ground corncob, ground rice hulls, ground walnut shells, ground almond shells, ground apricot shells, or diatomaceous earth, or combinations thereof. However, as noted below, particulate materials of a biological nature, that are not plant-based, may alternatively be used. The choice of filler may depend on the types of waste materials available in any particular manufacturing location.

In a particularly preferred embodiment, the filler is comprised of plant-derived waste particulate. In a most preferred embodiment, the filler is spent coffee grounds. The term “spent coffee grounds” refers to ground coffee beans once they have been used to make coffee. Thus, spent coffee grounds may alternatively be termed “recycled coffee grounds”, “used coffee grounds”, or “waste coffee grounds”.

The present invention may advantageously reduce the large volume of spent coffee ground waste produced worldwide by providing a second use for otherwise worthless used coffee grounds once they have fulfilled their primary purpose by being used to make coffee. The present invention may advantageously reduce the quantity of virgin (non-recycled) materials used in polymer composite manufacture, by replacing virgin material with spent coffee grounds.

The filler can alternatively, or additionally comprise inorganic particles. For example, sand, shell, or bone; or mineral particles, such as alkaline earth metal carbonate, (for example dolomite, i.e. CaMg(CO₃)₂, or calcium carbonate), metal sulphates (for example gypsum), metal silicates, metal oxides, metal hydroxides, kaolin, calcined kaolin, wollastonite, bauxite, talc or mica, including combinations thereof.

Any of the above filler materials may be coated (or uncoated) or treated (or untreated).

The surface of the particulate filler may be substantially unreactive, or undergo a chemical reaction with the components of the polymer composition. According to a preferred embodiment, the particulate filler is substantially unreactive with the components of the polymer composition.

### Additional Components

The polymer composition may optionally also comprise one or more additional components. The additional components may include solvents, catalysts, stabilisers, emulsifiers pH stabilisers, pH adjustors (e.g. agents for increasing the pH or decreasing the pH), anti-oxidants, pigments, opacifying agents, colourising agents, odorants or deodorants, anti-ozonants, such as surfactants, wetting agents, fertilizers, composting chemoattractants and/or defoamers.

Solvents are inert liquid carriers and may be used in the polymer composition. The solvent may be water or a suitable organic liquid. Examples include water, ethanol, methanol, isopropanol, acetonitrile, ethyl acetate, dimethylformamide, or toluene, or a mixture thereof. In a preferred embodiment, the solvent is water. While the composition may comprise solvent, in some embodiments, the polymer-forming composition contains low solvent (e.g. low water) or is substantially solvent free. Low solvent means that the composition contains at most 10%, at most 9%, at most 8%, at most 7%, at most 6% or at most 5% by weight water, based on the total weight of the composition. Low water means the same thing, but with water specified as the solvent (e.g. less than 10% water down to most preferably less than 5% water). Substantially solvent-free means that the composition contains less than 5% solvent, or not more than 4%, not more than 3%, not more than 2%, not more than 1% or no solvent based on the total weight of the composition. In a most preferred embodiment, the polymer-forming composition contains water as the only solvent, but in an amount of not more than 5% by weight of the composition.

The polymer composition may comprise a catalyst. Catalyst means any chemical species that is added to the composition for the purpose of lowering the activation potential of the crosslinking reaction. It is known in the art that a catalyst increases the rate of a reaction that it catalyses. A catalyst can induce unwanted side-reactions and remain as contamination in the final composition. Catalysts suitable for catalysing the crosslinking reaction of the present invention include mineral bases (such as sodium hydroxide, potassium hydroxide, etc.), organic bases (such as triethanolamine, triethylamine, ammonium salts, and others), enzymes (lipases, proteases, etc.), and mixtures thereof. However, in preferred embodiments, the composition has only a low catalyst content, or is essentially catalyst free. A low catalyst content refers to a catalyst amount that is not more than 5%, not more than 4%, not more than 3%, or not more than 2% based on the total weight of the composition. Essentially catalyst free refers to a catalyst amount that is not more than not more than 1%, not more than 0.5%, not more than 0.1%, or no catalyst. In a most preferred embodiment, the composition contains not more than 1% catalyst by weight of the composition.

Stabilisers may be used to aid blending of the polymer composition. The stabiliser may be, for example, an oleate, stearate or other non-ionic surfactants, potassium hydroxide, ammonium hydroxide and/or sodium hydroxide. The amount of stabiliser used is dependent on the components used in the polymer composition, the pH of the composition and other factors.

Emulsifiers may be used to aid blending of the polymer composition. Suitable emulsifiers include sodium alkyl sulphates or other non-ionic and ionic surfactants. The amount of emulsifier used is dependent on the polymer used in the polymer composition, the pH of the composition and other factors.

pH stabilisers may be used to avoid destabilization of the polymer-forming composition. Examples include acids for decreasing the pH, and alkalis for increasing the pH. Examples include hydrochloric acid, sulphuric acid, potassium hydroxide, ammonium hydroxide and/or sodium hydroxide.

Antiozonants may be used in the polymer composition. Suitable antiozonants include paraffinic waxes, microcrystalline waxes and intermediate types (which are blends of both paraffinic and microcrystalline waxes).

Antioxidants may be added to the polymer composition. Suitable antioxidants include hindered arylamines or polymeric hindered phenols, and Wingstal L (the product of p-cresol and dicyclopentadiene).

Pigments, such as (activated) charcoal (also known as activated carbon), titanium dioxide, and carbon black are selected for their pigmentation, or to reduce the transparency of the final product. Pigments may also be referred to as opaqueness providers. The pigments used in the polymer composition may also be selected from the group consisting of EN/USFDA approved dyes.

Odorants can include perfume oils of natural or synthetic origins. Odorants can also include compounds and substances that alter an odour by absorbing odour causing compounds, such as activated charcoal (i.e. functioning as a de-odorant). If present, the odorant is preferably a natural oil. The amount of odorant can range from about 0.0001 to 2.0% by weight.

Wetting agents may be used in the polymer composition. Suitable wetting agent emulsifiers include anionic surfactants like sodium dodecyl benzene sulphonate or sodium lauryl ether sulphate, or non-ionic ethoxylated alkyl phenols such as octylphenoxy polyethoxy ethanol or other non-ionic wetting agents. If present, the amount of wetting agent can range from about 0.0001 to 2.0% by weight.

Fertilisers and/or chemoattractant may be added to the composition to enhance composability of the final polymer article. Suitable fertilizers can include NPK fertilizers, urea, ammonium nitrate and calcium ammonium nitrate, or mixtures thereof. The fertilizer is preferably a bio-based fertilizer.

### Production Process

The polymer composition is formed into a polymer article through cross-linking of the polymer-forming composition. In suitable embodiments, the production process comprises blending the components of the polymer composition then crosslinking the polymer composition. The crosslinking may comprise exposing the composition to elevated temperatures. In the production process, exposure to or application of an elevated temperature can be continued until the composition has solidified into a final polymer article.

The ratio of the components of the composition will affect, among other characteristics, the crosslinking timeframe and the mechanical properties of the final polymer article. In some embodiments, the ratio of component (i) to component (ii) is effective for the production of a solid polymer following cross-linking. In some embodiments of the production process, the epoxidized oil of component (i) may be present in weight excess as compared to the polymer with multiple epoxide-reactive groups component (ii). The weight ratio of component (i) to component (ii) is preferably between than 20:1 and 1.5:1, preferably between 15:1 and 2:1, preferably between 12:1 and 2.5:1, preferably between 10:1 and 3:1, and more preferably between 9:1 and 3:1.

The inventors have further discovered that addition of a particulate filler to the composition can improve mechanical properties in the final polymer article. According to the disclosed production process, a particulate filler is added to the composition in a preferable amount of no more than 40%, of no more than 35%, of no more than 25%, of no more than 20%, or no more preferably no more than 35% by weight of the composition.

In preferred embodiments, blending (or similar terms mixing, combining, etc.) the polymer composition is achieved through subjecting the combined components of the composition to a suitable process in order to make the blended composition more homogenous. Homogenising or homogenisation of the composition is a transfer of the physical state of the composition to be essentially uniform across the composition. A homogenised composition is one where the degree of blending of the components of the composition is no longer qualitatively observed to change with further application of a blending process. In preferred embodiments, the composition is blended by stirring. Stirring means that the composition is exposed to a circular mixing action using for example a magnetic stirrer bar or paddle. In another preferred embodiment, stirring is continued until the polymer composition is homogenised.

The timeframe for blending the composition is not particularly limited. Those skilled in the art will recognise blending time is defined by factors such as the volume, mass and density of the components of the polymer composition; the relative amounts of each component present in the composition; the method, energy and/or rate of blending; the equipment used for blending, and other factors. Therefore, blending the composition can be undertaken over varying timeframes.

Homogenisation of the composition can be undertaken by blending methods other than stirring. In some embodiments, blending the composition is undertaken in batches using, for example, turbines (impellers), close-clearance mixers, and high-shear mixers, and others. In other embodiments, blending is undertaken continuously using, for example, in-line mixers, static mixers, or impinging mixers, and others.

The composition can be blended at a single temperature or over a range of temperatures. In a preferred embodiment, the composition is blended at ambient temperature. In another embodiment, the composition is blended at an elevated temperature. Blending at an elevated temperature can reduce the energy required for blending by lowering the viscosity of the composition. A moderately elevated temperature is preferred as the components of the composition react when heat is applied. Blending at a moderately elevated temperature means that the composition is held at a temperature of no more than 80° C., no more than 70° C., no more than 60° C., or no more than 50° C. while blending.

The production process may comprise crosslinking the blended composition by holding the blended composition at one or more elevated temperatures. Elevated temperatures cause the epoxide functional groups of component (i) and the epoxide-reactive groups of component (ii) of the blended composition to react to form covalent crosslinks between each other. Elevated temperature increases the reaction kinetics of the crosslinking reaction, wherein higher temperatures result in faster rates of crosslinking. The cross-linking may comprise subjecting the composition to an elevated temperature of at least 80° C., at least 90° C., at least 100° C., at least 110° C., at least 120° C., at least 130° C., at least 140° C., at least 150° C., or at least 160° C. for a time sufficient to crosslink the composition.

In some embodiments, the blended composition is crosslinked by holding the composition at a first temperature of at least 80° C., at least 90° C., at least 100° C., at least 110° C., at least 120° C., at least 130° C., at least 140° C., at least 150° C., or at least 160° C. for a time sufficient to crosslink the composition.

Elevated temperatures are also known in the art to potentially damage bio-based or plant-derived compounds. Damage can include burning, charring, oxidation and similar unwanted heat-derived effects. In a preferred embodiment, the composition is held at a temperature of no more than 185° C., no more than 180° C., no more than 175° C., no more than 170° C., no more than 165° C. during crosslinking. This upper limit serves to avoid or minimise the potential damage described above.

The timeframe required to crosslink the composition depends on the physical dimensions of the composition. In some embodiments, the blended composition is held at a temperature of at least 80° C., at least 90° C., at least 100° C., at least 110° C., at least 120° C., at least 130° C., at least 140° C., at least 150° C., or at least 160° C., for a timeframe of at least 12 hours, at least 1 day, at least 2 days, at least 3 days, at least 4 days, at least 5 days, at least 6 days, or at least 7 days to undertake crosslinking. Any of the above listed temperatures can be applied across any of the above-listed timeframes. For example, the composition can be held at 120° C. for 7 days, or be held at 150° C. for 1 day. Higher temperatures may require lower timeframes and lower temperatures may require higher timeframes to reach a similar degree of crosslinking.

In other embodiments, the blended composition is crosslinked by a two-step process comprising subjecting the composition to a first partial crosslinking step, followed by a second further crosslinking step. The first step comprises holding the composition at a first temperature for a first timeframe sufficient to partially crosslink the composition, followed by a second step comprising holding the partially crosslinked composition at a second temperature for a second timeframe sufficient to further crosslink the composition. In a preferred embodiment the second temperature is higher than the first temperature.

In some embodiments, the partial crosslinking step is conducted at a first temperature of at least 80° C., at least 90° C., at least 100° C., at least 110° C., or at least 120° C. for a first timeframe of at least 1 hour, at least 2 hours, at least 4 hours, at least 8 hours, at least 12 hours, at least 24 hours, at least 48 hours or least 36 hours. Any of the above listed first temperatures can be applied across any of the above-listed time frames for the partial crosslinking step. For example, the composition can be held at 90° C. for 4 hours, or held at 120° C. for 24 hours. In a preferred embodiment, the partial crosslinking step comprises holding the composition at 90° C. for 4 hours.

The further crosslinking step can be conducted at a temperature of least 90° C., at least 100° C., at least 110° C., at least 120° C., at least 130° C., at least 140° C., at least 150° C., or at least 160° C., for a second timeframe of at least 12 hours, at least 1 day, at least 2 days, at least 3 days, at least 4 days, at least 5 days, at least 6 days, or at least 7 days to undertake crosslinking. Any of the above listed temperatures can be applied across any of the above-listed timeframes. For example, the composition can be held at 120° C. for 7 days, or be held at 150° C. for 1 day.

The crosslinking process can comprise any partial crosslinking step combined with any further crosslinking step. As a preferred example, the composition can be partially crosslinked by holding at 90° C. for 4 hours, followed by being further crosslinked by holding at 150° C. for 1 day.

In some embodiments, the crosslinking process is conducted at a pressure above atmospheric pressure. In preferred embodiments, the crosslinking process is conducted at about atmospheric pressure.

In some embodiments, the production process is applied to reprocess polymer articles produced from a first production process. By reprocessing polymer articles, it is meant that two or more pieces or segments of crosslinked polymer article are contacted and exposed to the crosslinking stage according to the production process. Reprocessing can entail formation of crosslinks between the pieces or segments of polymer articles such as to make them one single polymer article.

In some embodiments, the production process is undertaken to produce discrete polymer articles. In other embodiments, the production process is conducted as a continuous process. Continuous processes can include, for example, extrusion and/or crosslinking under flow.

In some embodiments, the crosslinking process is partially or fully undertaken in a mould or shaping device. Employing a mould or shaping device is well known in the art to constrain the shape of the final polymer article to the physical dimensions of the mould or shaping device. The process may therefore comprise (a) blending the composition, (b) shaping the blended composition using a mould or shaping device, and (c) subjecting the shaped composition to a cross-linking process. The dimensions of the mould or shaping device can be selected on the basis of the desired dimensions of the polymer article. For example, the mould or shaping device can take the dimensions of a pot, cup, bowl, tooth brush, or other article capable of being composed of moulded plastic.

The scale of the production process is not particularly limited. The weight and/or volume of the composition that is crosslinked using the production process is determined by the desired dimensions of the final polymer article.

Polymer Products/Articles Formed from the Composition

The present disclosure also relates to polymer articles formed from the crosslinked composition of an epoxidized oil and a polymer containing multiple epoxide-reactive functional groups.

The polymer article can take any desirable physical form that can conventionally be formed using moulded plastic. For example, the polymer article can take the physical dimensions of a pot, cup, bowl, tooth brush, or other article capable of being composed of moulded plastic.

The polymer article can be post-processed. Post-processing refers to any processing step applied to the formed polymer after being initially crosslinked into a polymer article. Post processing may typically be undertaken to alter the physical or chemical characteristics of the article. Where the polymer article desirably comprises a dynamic reversible vitrimer network, the polymer article may advantageously be reformed after being cut, broken or otherwise disintegrated. Suitable post-processing steps include thermally, mechanically, or chemically reshaping the article, or exposing the article to conditions that facilitate (re) formation of the crosslinked polymer network. The polymer article may suitably be post-processed by extrusion. Processing by extrusion comprises comminuting the polymer article, heating to facilitate the reformation of crosslink bonds, compressing, and passing the compressed material through an orifice to form a post-processed polymer article with a long, thin aspect ratio.

The polymer article can be porous or non-porous. Porosity refers to a volume fraction of the polymer article being composed of voids or spaces free of crosslinked polymer. The polymer article may comprise closed-cell porosity, open-cell porosity, both closed and open cell porosity, or comprise little or no porosity. Closed cell porosity refers to the polymer article comprising internal voids that are inaccessible by fluid from the outer surface of the polymer article. Open cell porosity refers to the polymer article comprising internal voids that are interconnected and/or accessible by fluid from the outer surface of the polymer article. The polymer article may comprise a porosity of 0%, at least 5%, at least 10%, at least 20% at least 30%, at least 40%, at least 50%, or at least 60% of the total volume of the polymer article. Percent or volume porosity can be determined by any suitable method known in the art. A polymer article comprising porosity may be particularly suited to applications such as packaging or insulation. In preferred embodiments, the polymer article exhibits porosity.

In a preferred embodiment, the polymer article is biodegradable or compostable. The polymer article being biodegradable means that the polymer constituting the article is degraded into its constituent monomers and/or smaller polymer fragments by natural processes. The polymer article being compostable means the products of the natural degradation of the polymer constituting the article are substantially indistinguishable from bio-based or plant derived compounds. Natural processes relevant to degrading a polymer can include exposure to sunlight, water contact, moderately elevated temperatures (e.g. 25-50° C.) and the action of microbes and/or enzymes.

The polymer article is preferably one that is compostable in accordance with the test set out in Australian Standard AS 4736-2006. This test allows for the breakdown of a polymer material when exposed to compositing conditions. Under Australian Standard AS 4736-2006 a compostable material is one that meets the following requirements:
a minimum of 90% by mass biodegradation of materials within 180 days in compost; and
a minimum of 90% of materials disintegrate into less than 2 mm pieces in compost within 12 weeks; and
no toxic effect of the resulting degradation products on plants and animals; and
hazardous substances such as heavy metals in concentrations that do not exceed maximum allowed levels known in the art; and
at least 50% by mass organic materials.

In a most preferred embodiment, the polymer articles are compostable.

In some embodiments, the polymer article displays good mechanical properties. As an example, polymer articles formed from the polymer composition exhibit a good tensile strength. Tensile strength is the resistance of a material to breaking under tension.

In some embodiments, the polymer of the polymer article is one that exhibits a tensile strength of at least 0.01 MPa, based on a rectangular test sample of the polymer with dimensions 45 mm×8 mm×5 mm (length×width×thickness). The test conditions for assessment of tensile strength may involve loading of the sample at 10 N and 5 kN at 3 mm/min using an Instron mechanical analyser instrument. In preferred embodiments, a polymer article formed from the polymer composition has a tensile strength of at least 0.01 MPa, at least 0.02 MPa, at least 0.03 MPa, at least 0.05 MPa, at least 0.10 MPa, at least 0.15 MPa, at least 0.2 MPa, at least 0.25 MPa, at least 0.35 MPa, at least 0.3 MPa, or at least 0.4 MPa.

In some embodiments, the polymer article possesses a stress of at least 300 kPa at 20% strain, or a Young's modulus of 1,500 kPa.

In some embodiments, the polymer article possesses a stress of at least 800 kPa, suitably at least 1000 kPa, more suitably at least 1,500 kPa at 50% strain, or a Young's modulus of at least 1,600 kPa, suitably at least 2,000 kPa, or more suitably at least 3,000 kPa. Even more suitably, the polymer article exhibits a Young's modulus of at least 5,000 kPa, or most suitably at least 10,000 kPa.

In some embodiments, the polymer article possesses a yield strength of at least 1,000 kPa, suitably at least 2,000 kPa, more suitably at least 3,000 kPa.

In some embodiments, a test sample of the polymer that is subjected to reforming has a post-reforming tensile strength that is at least 20%, at least 30%, at least 40% or at least 50% of the original tensile strength value for the sample. The reforming test procedure involves:
Cutting a sample of the polymer into a multitude of pieces (of approximate 0.5×0.5 cm dimensions)
Placing the pieces into a cylindrical steel mould with 1 cm diameter cross-section and heating at 150° C. for 15 minutes
Compressing the pieces to re-form into a unitary disk of polymer at 150° C. for 30 minutes at a pressure of 8 MPa.
Demoulding the disk after the polymer is cooled to room temperature.

The reformed sample is cut in a rectangular shape (45 mm×8 mm×5 mm) for tensile strength testing. Tensile tests may be conducted on a universal testing machine (Instron) at a loading rate of 3 mm min⁻¹. The mechanical properties are suitably tested with 10 N and 5 kN load cell at 48% humidity.

In some embodiments, the reformed polymer sample of rectangular shape (45 mm×8 mm×5 mm) has an elongation at break of not more than 40%, 35% or 30%.

### Definitions

Unless specifically defined otherwise, all technical and scientific terms used herein shall be taken to have the same meaning as commonly understood by one of ordinary skill in the art (e.g., chemistry, biology, and the like).

It is to be understood that if any prior art publication is referred to herein, such reference does not constitute an admission that the publication forms a part of the common general knowledge in the art in Australia or any other country

As used herein, the term “and/or”, e.g., “X and/or Y” shall be understood to mean either “X and Y” or “X or Y” and shall be taken to provide explicit support for both meanings or for either meaning.

As used herein, the term about, unless stated to the contrary, refers to +/−10%, of the designated value. As used herein, “substantially all” refers to at least 90%, preferably at least 95%, at least 98% or 100%. As one example, these percentage amounts apply to embodiments where substantially all constituents of the polymer are derived from plant materials or bio-based materials. In this regard, it should be noted that an epoxidized plant-based oil is still considered to be plant-based constituent even following the epoxidation, given the epoxidation is a simple chemical modification of a functional group of the oil to allow for cross-linking.

Throughout this specification, unless specifically stated otherwise or the context requires otherwise, reference to a single step, composition of matter, group of steps or group of compositions of matter shall be taken to encompass one and a plurality (i.e. one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

As used herein, the word “comprise” and other forms of the word, such as “comprising” and “comprises,” means including but not limited to, and is not intended to exclude, for example, other additives, components, integers, or steps.

Each embodiment of the present disclosure described herein is to be applied mutatis mutandis to each and every other embodiment unless specifically stated otherwise, or required otherwise by context.

### EXAMPLES

Non-limiting examples will now be described, to further illustrate exemplary embodiments of the present invention.

### Reagents and General Methodology

All commercially obtained solvents and reagents were used without further purification. Chia Seed Oil (100%) was purchased from Earthyard Australia. Spent coffee grounds was taken from local café and was used as-is. Hydrogen peroxide 30% w/v, formic acid (98%) and anhydrous calcium chloride were purchased from Chemsupply. Reverse osmosis water was used for wetting the solid ingredients. Malic acid and alginic acid from brown algae was purchased from Sigma Aldrich. The constitution of the alginic acid can vary, but for the batch used the composition comprised 61% mannuronic acid and 39% guluronic acid. The average molecular weight was 240 kDa for this batch, and the experimentally determined carboxylic acid content was 22.1%.

The basic procedure for the production of the polymers in the examples involved taking the solid ingredients (filler (spent coffee grounds), crosslink agent (for example, alginic acid) and secondary cross-linker (for example, calcium chloride)) and manually mixing with the indicated volume of reverse osmosis water. To this pre-combined mixture of solid ingredients is then added the liquid epoxidized oil (for example, chia seed oil) and the mixture is again homogenised by manual stirring. The resulting mixture is then heated to 90° C. until in a flowing state, before pouring into a silicone mould and heating in an oven to the specified temperature for the desired thermosetting conditions (typically 150° C. unless otherwise indicated).

### Example 1: Vitrimer Type Dynamic Thermoset Produced by General Procedure without Filler and without Secondary Cross-Linking Agent

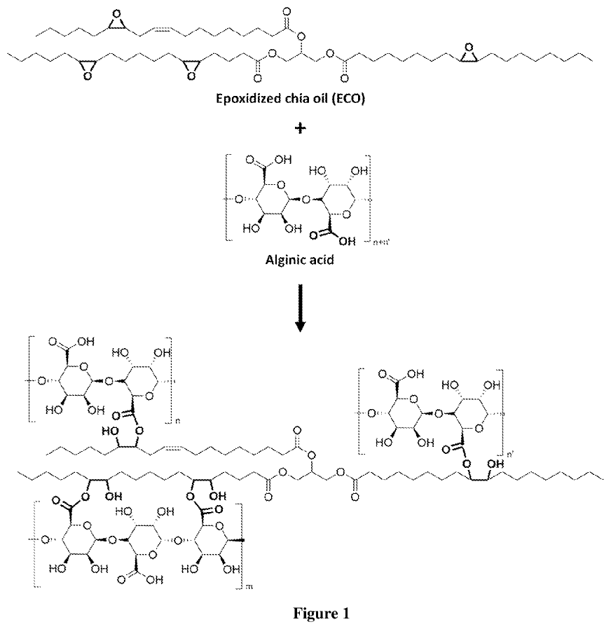

To a glass vial was added a polyacid (alginic acid) (0.96 g), solvent (reverse osmosis water) (0.24 g) and epoxidised oil (epoxidised chia seed oil) (5.00 g). The mixture was stirred until homogenous (ca. 60 s) before being placed in a conventional oven at 90° C. for 18 h. After this time, each sample was again stirred to homogenise (ca. 60 s) before being poured into silicone moulds (50 mm×20 mm×15 mm) and the temperature increased to 120° C. The films were then heated at this temperature for 7 days before allowing to cool to room temperature, then, demoulding. Where possible, prepared films were then cut into rectangular strips (45 mm×8 mm×5 mm) with precise measurements determined using digital callipers. These values were then entered in the Instron instrument and used to calculate the intrinsic mechanical properties. Mechanical testing was performed at the Australian National University College of Engineering using an Instron mechanical analyser instrument. The vitrimer type dynamic thermoset so produced was found to have favourable properties. Subsequent tests explored variations in the reagents and methods used, and also demonstrate the performance of the test samples. The crosslinked network containing ester alcohols were formed between the epoxidized chia seed oil and bio-based alginic acid (FIG. 1).

### Example 2: Modifications to Thermoset Temperature/Duration

The procedure for producing the vitrimer type dynamic thermoset of example 1 was repeated, but with variations in the curing conditions. In some samples, the mixture was heated to 90° C. for 36 h, then, 120° C. for 7 days, with all other procedures and compositions remaining constant. In these instances, there was no discernible difference in the samples produced compared to control.

In some samples, the mixture was heated to 120° C. for 24 h, with all other procedures and compositions remaining constant. In these instances, it was noted that the materials failed to form homogenous films, instead giving goo-like materials which failed to properly thermoset, and could not be mechanically tested.

In some samples, the mixture was heated to 120° C. for 7 days, with all other procedures and compositions remaining constant. In these instances, there was no discernible difference in the samples produced compared to control.

In some samples, the mixture was heated to 160-180° C., with all other procedures and compositions remaining constant. In these instances, the materials were observed to char or burn to an extent that destroyed the mixtures and made thermoset impossible.

In some samples, the mixture was heated to 90° C. for 4 h, then, to 150° C. for 24 h, with all other procedures and compositions remaining constant. In these instances, there was no discernible difference in the samples produced compared to control.

### Example 3: Tensile Strength Testing

The product of Example 1 was subjected to tensile strength tests using a universal testing machine (Instron) at a loading rate of 3 mm min⁻¹. The samples were cut in rectangular shapes (45 mm×8 mm×5 mm) to fit inside the clamps. The mechanical properties were tested two times with 10 N and 5 kN load cell at 48% humidity. The results are set out in Example 17 below (0% filler), as a comparison to the samples produced with varying filler amounts.

### Example 4: Reprocessing Polymers

Reprocessing experiment was performed on a PHI hydraulic press. The vitrimer type dynamic thermoset films produced in accordance with Example 1 were cut into small pieces (approx. 0.5×0.5 cm) and then placed into a cylindrical steel mould (with circular cross-section of 1 cm in diameter and approx. height 3 cm) and subjected to 15 min thermal equilibration at 150° C. at atmospheric pressure prior to reprocessing. The thermoset films were then reprocessed at 150° C. for 30 min at a pressure of 8 MPa. The reprocessed thermosets were demolded after reaching room temperature. After that the samples were cut in a rectangular shape (45 mm×8 mm×5 mm) to fit inside the clamps. Tensile tests were conducted on a universal testing machine (Instron) at a loading rate of 3 mm min⁻¹. The mechanical properties were tested with 10 N and 5 kN load cell at 48% humidity.

### Example 5: Epoxidised Chia Seed Oil, Alginic Acid Composition and Particulate Filler (Spent Coffee Grounds)

To a glass vial was added alginic acid (0.96 g), reverse osmosis water (0.24 g) and epoxidised chia seed oil (5.00 g), as well as a plant-derived particulate filler (spent coffee grounds) (500-1000 μm, in amounts of 0.62 g (10%), 1.24 g (20%) and 1.86 g (30% by weight)). The mixture was stirred until homogenous (ca. 60 s) before being placed in a conventional oven at 90° C. for 18 h. After this time, each sample was again stirred to homogenise (ca. 60 s) before being poured into silicone moulds (50 mm×20 mm×15 mm) and the temperature increased to 120° C. The films were then heated at this temperature for 7 days before allowing to cool to room temperature, then, demoulding. Prepared films were then cut into rectangular strips (45 mm×8 mm×5 mm) with precise measurements determined using digital callipers. These values were then entered in the Instron instrument and used to calculate the intrinsic mechanical properties. Mechanical testing was performed at the Australian National University College of Engineering using an Instron mechanical analyser instrument. The results are shown in Example 17 below.

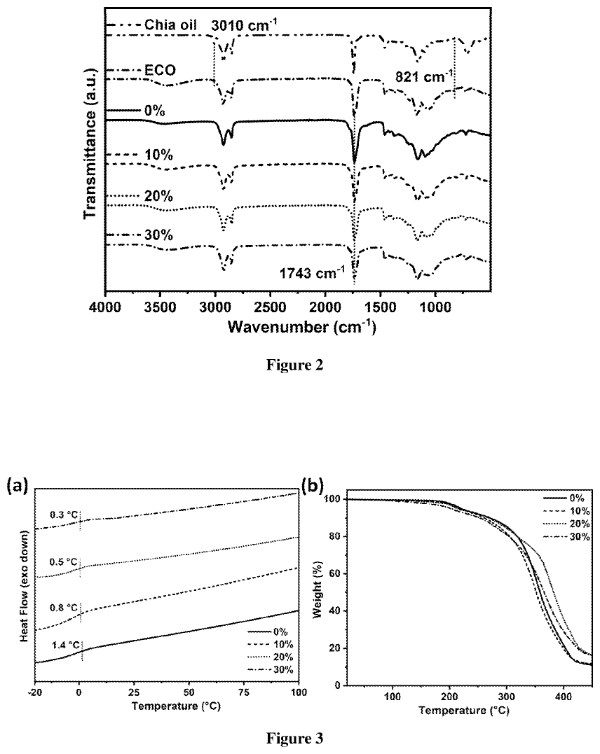

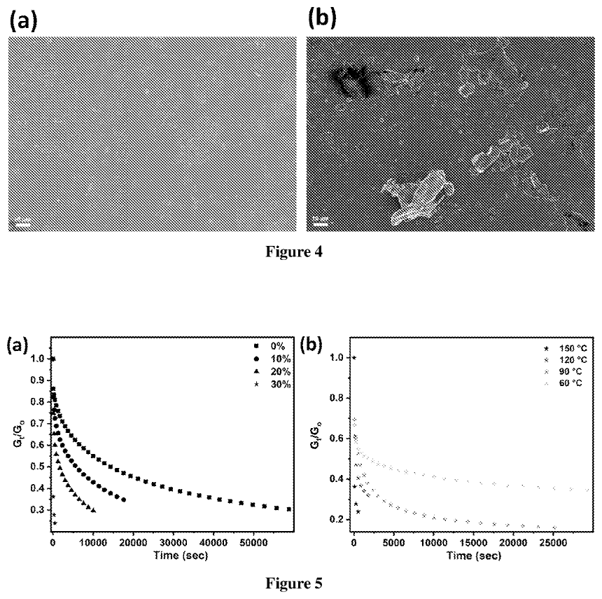

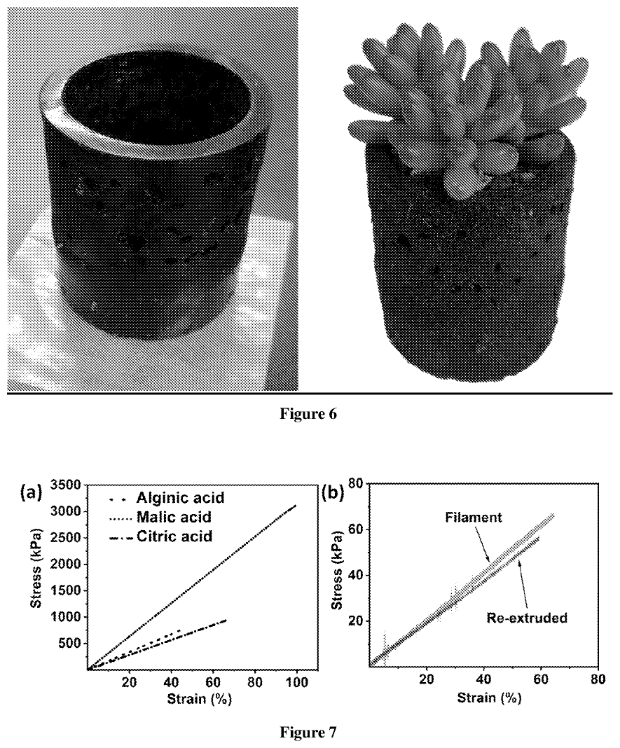

The chemical functionality of the prepared polymers was tested using Fourier-transform infrared spectroscopy (FTIR) (FIG. 2). The glass transition temperature (T_{g}) and thermal stability of polymers produced according to embodiments of the invention were measured using Differential Scanning calorimetry (DSC) (FIG. 3a) and Thermogravimetric Analysis (TGA) (FIG. 3b), respectively. The structure of the polymers produced according to embodiments of the invention were analysed using a scanning electron microscope (SEM) (FIG. 4). The stress relaxation of the polymers produced according to embodiments of the invention were investigated at 150° C. using a rheometer (FIG. 5a). The relaxation rate increases when the particulate filler content increase, owing to the corresponding decrease in crosslink density and/or the rise in residual OH concentration. The effect of temperature on the stress relaxation rate of the polymers produced according to embodiments of the invention containing 30% particulate filler was studied at different temperatures (FIG. 5b).

### Example 6: Epoxidised Chia Seed Oil/Spent Coffee Grounds Paste

To a glass vial was added alginic acid (0.96 g), reverse osmosis water (0.24 g) and epoxidised chia seed oil (5.00 g), as well as spent coffee grounds (500-1000 μm, varying amounts between 2.48-3.10 g). The mixture was stirred until homogenous (ca. 60 s) before being placed in a conventional oven at 90° C. for 18 h. After this time, each sample was again stirred to homogenise (ca. 60 s) before being poured into silicone moulds (50 mm×20 mm×15 mm) and the temperature increased to 120° C. The films were then heated at this temperature for 7 days before allowing to cool to room temperature, then, demoulding. In these instances, it was noted that the materials failed to form homogenous films, instead giving goo-like materials which failed to properly thermoset, and could not be mechanically tested.

### Example 7: Epoxidised Chia Seed Oil/Citric Acid/Alginic Acid/Spent Coffee Grounds Vitrimer type dynamic thermoset

To a glass vial was added alginic acid (0.48 g), citric acid (0.48 g), reverse osmosis water (0.24 g) and epoxidised chia seed oil (5.00 g), as well as spent coffee grounds (500-1000 μm, varying amounts between 0-1.86 g). The mixture was stirred until homogenous (ca. 60 s) before being placed in a conventional oven at 90° C. for 18 h. After this time, each sample was again stirred to homogenise (ca. 60 s) before being poured into silicone moulds (50 mm×20 mm×15 mm) and the temperature increased to 120° C. In these instances, the thermoset film produced was highly porous, rigid and brittle, and could not be set into a film of consistent dimensions, nor was mechanical testing practical or feasible. The addition of an excessive amount of citric acid as a secondary cross-linker was found to adversely impact on the polymer composition. However, it may be that other modifications to the polymer composition could allow for the production of an acceptable product with higher amounts of secondary cross-linker.

### Example 8: Epoxidised Chia Seed Oil/Citric Acid/Spent Coffee Grounds Vitrimer Type Dynamic Thermoset

To a glass vial was added citric acid (1.00 g), reverse osmosis water (0.24 g) and epoxidised chia seed oil (5.00 g), as well as spent coffee grounds (500-1000 μm, varying amounts between 0-1.86 g). The mixture was stirred until homogenous (ca. 60 s) before being placed in a conventional oven at 90° C. for 18 h. After this time, each sample was again stirred to homogenise (ca. 60 s) before being poured into silicone moulds (50 mm×20 mm×15 mm) and the temperature increased to 120° C. In these instances, the thermoset film produced was highly porous, rigid and brittle, and could not be set into a film of consistent dimensions, nor was mechanical testing practical or feasible. The complete replacement of the alginic acid with citric acid was found to be ineffective for the production of an acceptable polymer for our purposes.

### Example 9: Epoxidised Chia Seed Oil/Alginic Acid/Spent Coffee Grounds/Calcium Sulfate Dihydrate Vitrimer Type Dynamic Thermoset

To a glass vial was added alginic acid (0.96 g), reverse osmosis water (0.24 g) and epoxidised chia seed oil (5.00 g), as well as spent coffee grounds (500-1000 μm, varying amounts between 0-1.86 g), and calcium sulfate dihydrate as a secondary cross-linking agent (varying amounts between 0-0.62 g). The mixture was stirred until homogenous (ca. 60 s) before being placed in a conventional oven at 90° C. for 18 h. After this time, each sample was again stirred to homogenise (ca. 60 s) before being poured into silicone moulds (50 mm×20 mm×15 mm) and the temperature increased to 120° C. The films were then heated at this temperature for 7 days before allowing to cool to room temperature, then, demoulding. In these instances, there was no discernible difference in the samples produced compared to a control of the same formulation but without the calcium sulfate dihydrate.

### Example 10: Epoxidised Chia Seed Oil/Alginic Acid/Spent Coffee Grounds/Calcium (II) Chloride Vitrimer Type Dynamic Thermoset

To a glass vial was added alginic acid (0.96 g), reverse osmosis water (0.24 g) and epoxidised chia seed oil (5.00 g), as well as spent coffee grounds (500-1000 μm, varying amounts between 0-1.86 g), and calcium (II) chloride (varying amounts between 0-1.24 g). The mixture was stirred until homogenous (ca. 60 s) before being placed in a conventional oven at 90° C. for 18 h. After this time, each sample was again stirred to homogenise (ca. 60 s) before being poured into silicone moulds (50 mm×20 mm×15 mm) and the temperature increased to 120° C. The films were then heated at this temperature for 7 days before allowing to cool to room temperature, then, demoulding. In these instances, the toughness of the material increased with increasing calcium (II) chloride content (when compared to the same material without calcium (II) chloride), up until approximately 15% wt calcium (II) chloride, at which point the material become extremely brittle and mechanical testing was no longer feasible. The best properties were achieved with calcium chloride content of 7.5-10% in this example.

### Example 11: Epoxidised Chia Seed Oil/Alginic Acid/Spent Coffee Grounds/Activated Charcoal Vitrimer Type Dynamic Thermoset

To a glass vial was added alginic acid (0.96 g), reverse osmosis water (0.24 g) and epoxidised chia seed oil (5.00 g), as well as spent coffee grounds (500-1000 μm, varying amounts between 0-1.86 g), and activated charcoal (varying amounts between 0-0.62 g). The activated charcoal functions as both a pigment and additional filler, and also provides de-odorant properties. The mixture was stirred until homogenous (ca. 60 s) before being placed in a conventional oven at 90° C. for 18 h. After this time, each sample was again stirred to homogenise (ca. 60 s) before being poured into silicone moulds (50 mm×20 mm×15 mm) and the temperature increased to 120° C. The films were then heated at this temperature for 7 days before allowing to cool to room temperature, then, demoulding. Until approximately 5% wt activated charcoal content, no discernible change was observed when compared to the samples not containing activated charcoal, but at 10% wt activated charcoal the material failed to form a homogenous polymer and instead gave a powdery, sticky goo which was heterogeneous in nature.

### Example 12: Variations to Amount of Epoxidised Chia Seed Oil

Example 1 was repeated, but with an increased in the content of epoxidized chia seed oil to 10.00 g, with all other components remaining the same, and prepared following the same procedure. The amounts were 10 grams of epoxidized chia seed oil, 0.96 grams alginic acid and 0.24 grams water. It was found that the material failed to form a homogenous film, instead giving goo-like materials which failed to properly thermoset, and could not be mechanically tested. It is postulated that the excess amount of chia seed oil adversely impacted on the product. However, with an adjustment in the relative amounts and choices of components within the parameters described herein, it is anticipated that polymers with suitable properties could be produced.

### Example 13: Variations to Amount of Reverse Osmosis Water Added

Example 1 was repeated, but with an increase in the amount of reverse osmosis water up to 0.48 g. All other component amounts and procedures remained unchanged. With ECO referring to epoxidized chia seed oil, and SCGs referring to spent coffee grounds, the amounts of components in the formulations tested were:
(a) 5 g ECO|0.96 g alginic acid|0 g SCGs|0.24 g water
(b) 5 g ECO|0.96 g alginic acid|0 g SCGs|0.48 g water

This comparison test with increased solvent content produced no discernible change in the sample compared to the control.

Example 1 was also repeated but with the removal of all reverse osmosis water. All other procedures and compositions remained constant. The amounts of components in the formulations tested were:
(c) 5 g ECO|0.96 g alginic|0 g SCGs|0 g water

In this case, no discernible change in the film after thermosetting was observed, however, the mixing was less efficient.

Example 5 (with 0.69 g spent coffee grounds) was also repeated, but with an increase in the amount of reverse osmosis water up to 0.48 g. All other component amounts and procedures remained unchanged. The amounts of components in the formulations tested were:
(d) 5 g ECO|0.96 g alginic acid|0.69 g SCGs|0.24 g water
(e) 5 g ECO|0.96 g alginic acid|0.69 g SCGs|0.48 g water

This comparison test with increased solvent content produced no discernible change in the sample compared to the control.

Example 5 (with 0.69 g spent coffee grounds) was also repeated but with the removal of all reverse osmosis water. All other procedures and compositions remained constant. The amounts of components in the formulations tested were:
(f) 5 g ECO|0.96 g alginic acid|0.69 g SCGs|0 g water

In this case, no discernible change in the film after thermosetting was observed, however, the mixing was less efficient.

Example 8 (with citric acid in place of alginic acid) was also repeated, with adjustments in the amounts of spent coffee grounds and water content, and the results were also unchanged as compared to the results obtained in Example 8. The amounts of components in the formulations tested were as follows:
(g) 5 g ECO|0.96 g citric acid|0 g SCGs|0.24 g water
(h) 5 g ECO|0.96 g citric acid|0 g SCGs|0.48 g water
(i) 5 g ECO|0.96 g citric acid|0.69 g SCGs|0.24 g water
(j) 5 g ECO|0.96 g citric acid|0.69 g SCGs|0.48 g water

### Example 14: Variations to Amount of Alginic Acid Added

Example 1 was repeated, but with the addition of 20% (1.24 g) spent coffee grounds and adjustment in the amount of alginic acid used in the sample. In the variations of this example, the formulations tested were as follows:

| | | | Spent coffee | Epoxidised chia |
|---|---|---|---|---|
| Sample | Alginic acid (g) | Water (g) | grounds (g) | seed oil (g) |
| a. | 0.86 | 0.24 | 1.24 | 5.0 |
| b. | 0.96 | 0.24 | 1.24 | 5.0 |
| c. | 1.00 | 0.24 | 1.24 | 5.0 |
| d. | 1.20 | 0.24 | 1.24 | 5.0 |
| e. | 2.23 | 0.24 | 1.24 | 5.0 |

The procedure used remained consistent with the procedure set out in claim 1.

This test work showed that when less than 0.90 g of alginic acid was used (as demonstrated by the 0.86 g alginic acid sample) the material failed to thermoset and instead gave a heterogeneous, sticky goo. When between about 0.95-1.10 g of alginic acid was used (as demonstrated by the 0.96 g and 1.00 g alginic acid samples), the polymer film produced was flexible and mechanically strong. When between about 1.12-1.20 g of alginic acid was used (based on what was learned from the 1.00 and 1.2 g alginic acid samples), the film produced successfully thermoset into a homogenous film, but the film was brittle, inflexible and cracked readily. In amounts greater than 2.00 g (based on the 2.23 g alginic acid samples), the mixtures failed to thermoset, and instead gave heterogeneous and sticky mixtures. This work demonstrates the desired relative amount of alginic acid to epoxidized chia seed oil. If the oil (and iodine value) was to change, and/or variations were made in the other components and amounts, or variations were made in the type of polyacid, then it is possible that different ratios could be accommodated.

### Example 15: Properties of Tested Products

The properties of the samples of Example 1 and Example 5 (with zero filler, and between 10% and 30% by weight filler) were assessed.

| | | | | Tensile strength |
|---|---|---|---|---|
| | | | | recovery of |
| | | Tensile | | reprocessed |
| | | Strength | | sample (% of |
| Pristine | | (MPa) | Elongation (%) | original) |
| 0% | (Example 1) | 0.84 | 47.76 | 32 |
| 10% | (Example 5) | 0.21 | 11.07 | 66 |
| 20% | (Example 5) | 0.14 | 27.26 | 28 |
| 30% | (Example 5) | 0.03 | 16.31 | 95 |

Test samples of the polymers produced in accordance with Examples 1 and 5, with the indicated % of coffee ground filler (0% to 30%) were obtained with dimensions 45 mm×8 mm×5 mm (length×width×thickness). The samples were subjected to tensile strength testing (measured in MPa) and testing for elongation at break (measured as a %), and the results are shown in the table set out above. The samples were then subjected to reprocessing in accordance with the procedure set out in Example 4 and then the tensile strength re-tested in accordance with the procedure set out in Example 4. The tensile strength output was recorded as a % of the original tensile strength measurement.

### Example 16: Vitrimer Type Dynamic Thermoset Produced by General Procedure without Filler and with Secondary Cross-Linking Agents

To a glass vial was added a polyacid (alginic acid) (0.96 g), dicarboxylic acid (malic acid) (0.96 g), tricarboxylic acid (citric acid) (0.96 g), solvent (reverse osmosis water) (0.24 g) and epoxidised oil (epoxidised chia seed oil) (5.00 g). The mixture was stirred until homogenous (ca. 60 s) before being placed in a conventional oven at 90° C. for 18 h. After this time, each sample was again stirred to homogenise (ca. 60 s) before being poured into silicone moulds (50 mm×20 mm×15 mm) and the temperature increased to 120° C. The films were then heated at this temperature for 7 days before allowing to cool to room temperature, then, demoulding. Where possible, prepared films were then cut into rectangular strips (45 mm×8 mm×5 mm) with precise measurements determined using digital callipers. These values were then entered in the Instron instrument and used to calculate the intrinsic mechanical properties. Mechanical testing was performed at the Australian National University Research School of Chemistry using an Instron mechanical analyser instrument. The vitrimer type dynamic thermoset so produced was found to have favourable properties (FIG. 7a).

### Example 17: Vitrimer Type Dynamic Thermoset Produced by General Procedure with Fillers and with Secondary Cross-Linking Agent

To a glass vial was added a polyacid (alginic acid) (0.96 g), dicarboxylic acid (malic acid) (0.96 g), tricarboxylic acid (citric acid) (0.96 g), solvent (reverse osmosis water) (0.24 g), and fillers (30 wt %) and epoxidised oil (epoxidised chia seed oil) (5.00 g). The mixture was stirred until homogenous (ca. 60 s) before being placed in a conventional oven at 90° C. for 18 h. After this time, each sample was again stirred to homogenise (ca. 60 s) before being poured into silicone moulds (50 mm×20 mm×15 mm) and the temperature increased to 120° C. The films were then heated at this temperature for 7 days before allowing to cool to room temperature, then, demoulding. Where possible, prepared films were then cut into rectangular strips (45 mm×8 mm×5 mm) with precise measurements determined using digital callipers. These values were then entered in the Instron instrument and used to calculate the intrinsic mechanical properties. Mechanical testing was performed at the Australian National University Research School of Chemistry using an Instron mechanical analyser instrument. The vitrimer type dynamic thermoset so produced was found to have favourable properties.

### Example 18: Alternative Heating Profiles

In some samples, the mixture according to Example 17 was heated to 90° C. for 1 h, then 120° C. for 1 h, then 140° C. for 18 h, with all other procedures and compositions remaining constant. In these instances, there was no discernible difference in the samples compared to control.

### Example 19: Epoxidised Chia Seed Oil/Citric Acid Vitrimer Type Dynamic Thermoset

To a glass vial was added citric acid (0.96 g), reverse osmosis water (0.24 g) and epoxidised chia seed oil (5.00 g). The mixture was stirred until homogenous (ca. 60 s) before being placed in a conventional oven at 90° C. for 1 h. After this time, each sample was again stirred to homogenise (ca. 60 s) before being poured into silicone moulds (50 mm×20 mm×15 mm) and the temperature increased to 120° C. for 1 h. After this time, each sample was again stirred to homogenise (ca. 60 s) before the temperature was increased to 140° C. The films were then heated at this temperature for 18 h before allowing to cool to room temperature, then, demoulding. In these instances, a porous, rigid film with high toughness and Young's modulus was obtained (1060±270 kPa, n=4, see FIG. 7).

### Example 20: Epoxidised Chia Seed Oil/Malic Acid Vitrimer Type Dynamic Thermoset

To a glass vial was added malic acid (0.96 g), reverse osmosis water (0.24 g) and epoxidised chia seed oil (5.00 g). The mixture was stirred until homogenous (ca. 60 s) before being placed in a conventional oven at 90° C. for 1 h. After this time, each sample was again stirred to homogenise (ca. 60 s) before being poured into silicone moulds (50 mm×20 mm×15 mm) and the temperature increased to 120° C. for 1 h. After this time, each sample was again stirred to homogenise (ca. 60 s) before the temperature was increased to 140° C. The films were then heated at this temperature for 18 h before allowing to cool to room temperature, then, demoulding. In these instances, a transparent, orange film with high toughness and Young's modulus was obtained (20920±2110 kPa, n=4, see FIG. 7).

### Example 21: Epoxidised Chia Seed Oil/Alginic Acid/Malic Acid/Spent Coffee Grounds Vitrimer Type Dynamic Thermoset

To a glass vial was added alginic acid (0.96 g), malic acid (0.96 g), reverse osmosis water (0.24 g) and epoxidised chia seed oil (5.00 g), as well as spent coffee grounds (500-1000 μm, varying amounts between 0-1.86 g). The mixture was stirred until homogenous (ca. 60 s) before being placed in a conventional oven at 90° C. for 1 h. After this time, each sample was again stirred to homogenise (ca. 60 s) before being poured into silicone moulds (50 mm×20 mm×15 mm) and the temperature increased to 120° C. for 1 h. After this time, each sample was again stirred to homogenise (ca. 60 s) before the temperature was increased to 140° C. The films were then heated at this temperature for 18 h before allowing to cool to room temperature, then, demoulding. In these instances, a rigid, tough brown material was obtained for which mechanical testing was not feasible.

### Example 22: Epoxidised Chia Seed Oil/Alginic Acid/Malic Acid/Spent Coffee Grounds Vitrimer Type Dynamic Thermoset

To a glass vial was added alginic acid (0.96 g), malic acid (0.48 g), citric acid (0.48 g), reverse osmosis water (0.24 g) and epoxidised chia seed oil (5.00 g), as well as spent coffee grounds (500-1000 μm, varying amounts between 0-1.86 g). The mixture was stirred until homogenous (ca. 60 s) before being placed in a conventional oven at 90° C. for 1 h. After this time, each sample was again stirred to homogenise (ca. 60 s) before being poured into silicone moulds (50 mm×20 mm×15 mm) and the temperature increased to 120° C. for 1 h. After this time, each sample was again stirred to homogenise (ca. 60 s) before the temperature was increased to 140° C. The films were then heated at this temperature for 18 h before allowing to cool to room temperature, then, demoulding. In these instances, a rigid, tough brown material was obtained for which mechanical testing was not feasible.

### Example 23: Variations to Amount of Alginic Acid Added

Example 16 and Example 17 was repeated, but with a variation in the amount of alginic acid used in the sample. In the variations of this example, alginic acid (varying amounts between 0.1-2.23 g) was used in place of the amount set out in Example 16 and Example 17, with all other procedures and compositions remaining constant. When alginic acid (varying amounts between 0.1-2.23 g) was used, the polymer film produced was homogenous flexible thermoset film.

### Example 24: Variations to Amount of Citric Acid Added

Example 16 and Example 17 was repeated, but with a variation in the amount of citric acid used in the sample. In the variations of this example, citric acid (varying amounts between 0.1-2.23 g) was used in place of the amount set out in Example 16 and Example 17, with all other procedures and compositions remaining constant. This test work showed that when citric acid (varying amounts between 0.1-2.23 g) was used the material become porous heterogenous thermoset. This work demonstrates the desired relative amount of citric acid to epoxidized chia seed oil. If the oil (and iodine value) was to change, and/or variations were made in the other components and amounts, or variations were made in the type of polyacid, then it is possible that different ratios could be accommodated.

### Example 25: Variations to Amount of Malic acid Added

Example 16 and Example 17 were repeated, but with a variation in the amount of malic acid used in the sample. In the variations of this example, between malic acid (varying amounts between 0.1-2.23 g) was used in place of the amount set out in Example 16 and Example 17, with all other procedures and compositions remaining constant. This test work showed that when malic acid (varying amounts between 0.1-2.23 g) was used the material become very hard homogenous thermoset. This work demonstrates the desired relative amount of malic acid to epoxidized chia seed oil. If the oil (and iodine value) was to change, and/or variations were made in the other components and amounts, or variations were made in the type of polyacid, then it is possible that different ratios could be accommodated.

### Example 26: Variations to Amount of Filler Added

Example 16 and Example 17 were repeated, but with a variation in the amount of filler used in the sample. In the variations of this example, between filler (varying amounts between 0.1 g-2.23 g) was used in place of the amount set out in Example 16 and Example 17, with all other procedures and compositions remaining constant. This test work showed that when filler (varying amounts between 0.1-1.24 g) was used the material becomes soft homogenous thermoset. When the filler (varying amounts between (1.24 g-2.23 g) was used the material becomes a viscous liquid. This work demonstrates the desired relative amount of filler to produce the thermoset materials. If the oil (and iodine value) was to change, and/or variations were made in the other components and amounts, or variations were made in the type of polyacid, then it is possible that different ratios could be accommodated.

### Example 27: Extruding Polymers

Extruding experiment was performed on a Filabot EX2 Filament Extruder. The vitrimer type dynamic thermoset films produced in accordance with Example 16 and Example 17 were cut into small cube pieces (approx. 0.5×0.5×0.5 cm) and then placed into extruder hopper, which grinds, heats, compresses, and ultimately extrudes the polymer at 110-175° C. through a 1.75 diameter nozzle. The thermoset vitrimeric films were then re-extruded at 110-175° C. The re-extruded thermoset filaments were spooled after reaching room temperature. After that the samples were cut to fit inside the clamps. Tensile tests were conducted on a universal testing machine (Instron) at a loading rate of 3 mm min⁻¹. The mechanical properties were tested with 10 N and 5 kN load cell at 48% humidity (FIG. 7b).

1-22. (canceled)

23. A composition for the production of a polymer article, the composition comprising:
an epoxidized oil derived from an oil with an iodine value of at least 100; and
two or more crosslink agents, each having multiple epoxide-reactive groups, wherein the two or more crosslink agents improve mechanical properties of the polymer article.

24. The composition according to claim 23, wherein component (ii) comprises one or more poly-carboxylic acids or a salt or ester thereof.

25. The composition according to claim 23, wherein component (ii) comprises at least a first crosslink agent having a molecular weight not exceeding 160 g/mol, and a second crosslink agent having a molecular weight not less than 10,000 g/mol.

26. The composition according to claim 23, wherein component (ii) comprises at least one crosslink agent selected from the group consisting of citric acid, tartaric acid, malic acid, malonic acid, succinic acid, glutaric acid, adipic acid, pimelic acid, suberic acid, azelaic acid, or a salt or ester thereof.

27. The composition according to claim 23, wherein component (ii) comprises at least one crosslink agent selected from the group consisting of alginic acid, carboxylated polysaccharides, polylactic acid, polyacrylic acid, polymethacrylic acid, pectin, glycosaminoglycan, hyaluronic acid, tannic acid, or a salt or ester thereof.

28. The composition according to claim 23, further comprising:
(iii) a filler, wherein the filler is optionally a plant-derived fibre and/or particulate material.

29. The composition according to claim 23, wherein the composition is substantially derived from bio-based or plant-derived feedstocks.

30. A process for the production of a polymer article comprising subjecting a composition comprising:
an epoxidized oil derived from an oil with an iodine value of at least 100; and
two or more crosslink agents, each having multiple epoxide-reactive groups
to cross-linking conditions to produce the polymer article, wherein the two or more crosslink agents improve mechanical properties of the polymer article.

31. The process according to claim 30, wherein the cross-linking conditions comprise heating at a temperature of between 120° C. and 150° C.

32. The process according to claim 31, wherein the process is undertaken partly or fully in a mould or shaping device.

33. The process according to claim 31, wherein the process comprises a further step of moulding or shaping the polymer article, optionally wherein the process further comprises an extrusion step.

34. The process according to claim 31, wherein at least a portion of the polymer article is post-processed by subsequent exposure to conditions suitable for cross-linking.

35. A crosslinked polymer produced from a composition comprising:
an epoxidized oil derived from an oil with an iodine value of at least 100, and
two or more crosslink agents, each having multiple epoxide-reactive group, wherein the two or more crosslink agents improve mechanical properties of the crosslinked polymer.

36. The crosslinked polymer according to claim 35, wherein the crosslinked polymer is substantially derived from bio-based or plant-derived feedstocks and the polymer is compostable in accordance with Australian Standard AS 4736-2006.

37. The crosslinked polymer according to claim 35, wherein the crosslinked polymer is porous.

38. The crosslinked polymer according to claim 35, wherein the crosslinked polymer exhibits one or more properties selected from:
i) a Young's modulus of at least 1,500 kPa,
ii) a yield strength of at least 1,000 kPa; and
iii) a tensile strength of at least 0.01 MPa.

39. The crosslinked polymer according to claim 35, wherein the crosslinked polymer is a vitrimer type dynamic thermoset.

40. The vitrimer type dynamic thermoset according to claim 39, further comprising a bio-based filler, optionally wherein the bio-based filler is spent coffee grounds.
